(19) United States
(12) Patent Application Publication
(10) Pub. No.: US 2008/0005728 A1
(43) Pub. Date: Jan. 3, 2008

(54) Methods, systems, and computer program products for enabling cross language access to an addressable entity in an execution environment

(76) Inventor: Robert Paul Morris, Raleigh, NC (US)

Correspondence Address: SCENERA RESEARCH, LLC;JENKINS, WILSON & TAYLOR, P.A., 3100 TOWER BLVD, SUITE 1400, DURHAM, NC, 27707, US

(21) Appl. No.: 11/478,908

(22) Filed: Jun. 30, 2006

(51) Int. Cl. G06F 9/45

(52) U.S. Cl. 717/153

(57) ABSTRACT

Methods, systems, and computer program products for enabling cross language access of an addressable entity in an execution environment are disclosed. According to one method, an unresolved reference entity is detected in a first object code generated from first source code written in a first programming language, where a portion of the first object code using the unresolved reference entity is generated by a compiler of the first source code using an execution model associated with an addressable entity referenced by the unresolved reference entity. An addressable entity is located in a second object code generated from second source code written in a second programming language, where the located addressable entity has an associated alias symbol from a namespace of the first programming language. It is determined whether the located addressable entity is the referenced addressable entity by matching a symbol associated with the unresolved reference entity with the alias symbol associated with the located addressable entity. In response to determining that the symbol associated with the unresolved reference entity matches the alias symbol, the unresolved reference entity is resolved to the located addressable entity using an identifier, wherein the identifier is associated with a storage area associated with the located addressable entity and wherein the located addressable entity is generated by a compiler of the second source code and conforms to the execution model used by the compiler of the first source code to generate the portion of the first object code using the referenced addressable entity. The portion of the first object code using the resolved reference entity is allowed to access the located addressable entity via the storage area associated with the identifier as a result of the use of the shared execution model by the compilers of the first and second source code.

### RELATED APPLICATIONS

This application is related to U.S. patent application Ser. No. ______, titled “Methods, Systems, and Computer Program Products for Generating and Using Object Modules,” (Attorney Docket No. I-411), filed on even date herewith and assigned to the same assignee as this application, U.S. patent application Ser. No. ______, titled “Methods, Systems, and Computer Program Products for Providing a Program Execution Environment,” (Attorney Docket No. I-370), filed on even date herewith and assigned to the same assignee as this application, and U.S. patent application Ser. No. ______, titled “Methods, Systems, and Computer Program Products for Enabling Cross Language Access to an Addressable Entity,” (Attorney Docket No. I-393), filed on even date herewith and assigned to the same assignee as this application, the disclosures of which is incorporated here by reference in their entirety.

### TECHNICAL FIELD

The subject matter described herein relates to generating computer entities that are accessible via different programming languages. More particularly, the subject matter described herein relates to methods, systems, and computer program products for enabling cross language access to an addressable entity in an execution environment.

### BACKGROUND

Numerous programming languages are in use today. However, object modules produced from different programming languages often cannot directly interact with each other. Some difficulties in cross-language access may arise due to differing built-in data type definitions between the execution model utilized by the invoking program and the execution model utilized by the invoked addressable entity. Other cross-language reference problems may arise due to differing access models for function, subroutine, and/or method calls, including incompatible models of parameter passing and control flow. Further, each programming language may incorporate a unique memory model whose definition affects compilation of source code, linking and loading of object code derived from the source code. These problems are defined as execution model problems in this document.

Translation mechanisms currently exist to permit cross-language access of addressable entities typically using a set of bindings, one per referenced foreign programming language entity, and/or a middleware component to do the various conversions and translations. Language-specific bindings may be included in a source code file typically separate from the program code to explicitly provide a data structure and/or an executable routine to ensure that the invoked addressable entity and the invoking program can work together. System level middleware may be structured to receive invocation calls through one or more invocation bindings and perform namespace and execution model conversion operations including one or more data type conversions, access method translations, and/or memory model translations. Translation mechanisms, in effect, translate between the different execution models used in generating object code from different programming languages.

Build tools currently exist to enable the generation of the bindings and/or provide the middleware conversions and translations. However, each tool may be written to support a specific target programming language as there are no commonly accepted language-neutral tools available. Furthermore, current build tools and processes produce sections of source code in order to support an identified cross-language access operation that may perform no other function in the program. The source code providing cross-language access requires additional disk space, memory, CPU cycles and may also introduce additional code and/or execution defects in the software product. Additionally, few debugging tools provide cross language execution support, thus making software design, validation, and support in a heterogeneous language environment extremely difficult and time-consuming.

Accordingly, in light of the above described difficulties associated with existing methods for enabling cross language access of computer programs, there exists a need for improved methods, systems, and computer program products for enabling cross language access of an addressable entity.

### SUMMARY

According to one aspect, the subject matter described herein includes a method for enabling cross language access to an addressable entity in an execution environment. The method includes detecting an unresolved reference entity in a first object code generated from first source code written in a first programming language. The method further includes generating a portion of the first object code using the unresolved reference entity by a compiler of the first source code using an execution model associated with an addressable entity referenced by the unresolved reference entity. The method further includes locating an addressable entity in a second object code generated from second source code written in a second programming language. The located addressable entity has an associated alias symbol from a namespace of the first programming language. The method further includes determining whether the located addressable entity is the referenced addressable entity by matching a symbol associated with the unresolved reference entity with the alias symbol associated with the located addressable entity. The method further includes, in response to determining that the symbol associated with the unresolved reference entity matches the alias symbol, resolving the unresolved reference entity to the located addressable entity using an identifier. The identifier is associated with a storage area associated with the located addressable entity. The located addressable entity is generated by a compiler of the second source code and conforms to the execution model used by the compiler of the first source code to generate the portion of the first object code using the referenced addressable entity. The method further includes allowing the portion of the first object code using the resolved reference entity to access the located addressable entity via the storage area associated with the identifier as a result of the use of the shared execution model by the compilers of the first and second source code.

According to another aspect, the subject matter described herein includes a method for enabling cross language access to an addressable entity in an execution environment. The method includes detecting an unresolved reference entity in a first object code generated from first source code written in a first programming language. A portion of the first object code using the unresolved reference entity is generated by a compiler of the first source code using an execution model associated with an addressable entity referenced by the unresolved reference entity and the unresolved reference entity has an associated alias symbol from a namespace of a second programming language. The method further includes generating an addressable entity in a second object code generated from second source code written in the second programming language is located. The method further includes determining whether the located addressable entity is the referenced addressable entity by matching the alias symbol associated with the unresolved reference entity with a symbol associated with the located addressable entity. The method further includes, in response to determining that the symbol associated with the addressable entity matches the alias symbol, resolving the unresolved reference entity to the located addressable entity using an identifier. The identifier is associated with a storage area associated with the located addressable entity and wherein the located addressable entity is generated by a compiler of the second source code and conforms to the execution model used by the compiler of the first source code to generate the portion of the first object code using the referenced addressable entity. The method further includes allowing the portion of the first object code using the resolved reference entity to access the located addressable entity via the storage area associated with the identifier as a result of the use of the shared execution model by the compilers of the first and second source code.

As used herein, an “addressable entity” refers to any addressable part of or all of a computer program. For example, an addressable entity may be one or more source, object, or intermediate representations of a function, a variable, a constant, a data structure, or a class for example. The term “addressable data entity” includes variables and constants including simple and structure; static, global, and dynamic instances. The term “addressable instruction entity” includes functions, methods, subroutines, labeled instructions, and anonymous code blocks. Whether variants of the term “addressable entity” refer to source entities, object code entities, or intermediate representations will be clear from the context where the terms are used.

“Object code” as used herein refers to any representation of source code resulting from processing of the source code by at least one of a compiler, linker, and loader. “Object module” as used herein refers to object code resulting from the processing of a source code file or independent source code storage entity by at least one of a compiler, linker, and loader. For example, processing of a source code file results in the generation of an object module which may be said to be or to contain object code. Object code may refer to an object module, a portion of an object module, or object code from more than one object module.

“Memory model” as used herein refers specifically to the layout an addressable entity or memory area in processor memory used by object code which includes order of elements, size of elements, memory alignment constraints, type constraints, and data constraints. The development tools and execution environment may implicitly or explicitly use or be constrained a memory model associated with the generation of object code from source code using the tools in association with the target execution environment.

As used herein, the term “namespace” refers to a set of valid symbols that may be generated for and associated with addressable entities by at least one of a compiler, linker, loader, or an interpreter. The namespace may be defined and managed by a compiler or other build tool for a supported programming language. A linker and/or a loader may modify compiler generated symbols during linking and loading. In a preferred embodiment, a compiler, linker, loader, and/or interpreter may use an external resource for namespace definition and management.

“Execution model” as used herein includes a memory model, access models, and register usage model used by a compiler, linker, and/or loader in generating and executing object code from source code written in a particular language. Traditionally a single execution model may be used in generating object code from a source code written using a programming language. The execution model may be used by a compiler, linker, and/or loader to generate object code that correctly presents a reference for the addressable entity to support an access of a referenced entity. For example, an execution model applied to a single data variable may define the type of the variable, the size of the memory area, its offset into a data segment, and its memory alignment. An execution model for a function may include the model for layout of the function's stack frame or other instance data area, the register(s) usage model for accessing entities in the instance data area, the model for entity types, and the memory alignment model specifying the memory align of the first instruction affecting the instructions address. The function's compiler, linker, and loader may use the execution model information to generate object code conforming to the model enabling access to the function and enabling the function to access the data each function instance requires. The execution model may also specify whether data entities used by the function are passed by value or passed by reference.

The terms “compiler”, “linker”, and “loader” include tools that perform equivalent functions such as interpreters, assemblers, byte code compilers, and byte code interpreters. Further, “execution environment”, “processor”, “register” and other computer environment terms include virtual representations of these entities.

As used herein, the term “alias symbol” refers to a symbol that is a valid name in the namespace associated with a target foreign programming language. Thus “alias symbol” is a relative term. For example, a symbol table in an object module generated by a C compiler may include an alias symbol from a Fortran 90 namespace used to access an addressable entity defined in a Fortran 90 namespace.

One exemplary execution environment suitable for use with embodiments of the subject matter described herein is described in a commonly-assigned, co-pending U.S. patent applications entitled “Methods, Systems, and Computer Program Products for Generating and Using Object Modules,” (Attorney Docket No. I-411) and “Methods, Systems, and Computer Program Products for Providing a Program Execution Environment,” (Attorney Docket No. I-370), both filed on even date herewith. The exemplary execution environment described in the co-pending applications may be embodied such that it is capable of supporting a single shared execution model for all object code compiled, linked, and loaded into the execution environment for all supported source code languages.

The subject matter described herein may be implemented using a computer program product comprising computer executable instructions embodied in a computer-readable medium. Exemplary computer-readable media suitable for implementing the subject matter described herein include chip memory devices, disk memory devices, programmable logic devices, application specific integrated circuits, and downloadable electrical signals. In addition, a computer-readable medium that implements the subject matter described herein may be distributed as represented by multiple physical devices and/or computing platforms.

### BRIEF DESCRIPTION OF THE DRAWINGS

FIG. 1 is a block diagram of first and second source code files written in different programming languages, corresponding object modules, and a complier/loader/linker for enabling cross-language access to an addressable entity according to an embodiment of this subject matter described herein;

FIGS. 2A and 2B illustrate exemplary symbol table entries generated by the compiler/linker/loader illustrated in FIG. 1;

FIG. 3 is a flow chart of an exemplary process for enabling cross-language support of an addressable program entity according to an embodiment of the subject matter described herein;

FIG. 4 is a flow chart of an exemplary process for enabling cross language access to an addressable entity according to an embodiment of the subject matter described herein;

FIG. 5 is an exemplary C language source code listing illustrating an exemplary C language extension enabling source code from another programming language to be embedded in C language source code according to an embodiment of the subject matter described herein;

FIG. 6A is an exemplary C language source code listing comprising exemplary C language extensions enabling references to addressable entities written in another language and identifying another language to be allowed access to an addressable entity implemented in C according to an embodiment of the subject matter described herein;

FIG. 6B is an exemplary symbol table entry associated with an addressable entity, the addressable entity capable of being invoked from an object module written in any of a plurality of explicitly identified programming languages according to an embodiment of the subject matter described herein;

FIG. 7 is a diagram of an exemplary execution environment for a cross-language addressable entity reference using a shared execution model according to an embodiment of the subject matter described herein;

FIG. 8 is a diagram of a build toolset that may be utilized by a complier, a linker, and/or a loader to generate, resolve, and load a cross language access of an addressable entity according to an embodiment of the subject matter described herein;

FIG. 9 is a diagram of an exemplary execution environment for a cross language access enabled using an access record according to an embodiment of the subject matter described herein;

FIG. 10 is a flow chart of an exemplary process for enabling cross language access to an addressable entity in an execution environment according to an embodiment of the subject matter described herein; and

FIG. 11 is a flow chart of an exemplary process for enabling cross language access to an addressable entity in an execution environment according to an embodiment of the subject matter described herein.

### DETAILED DESCRIPTION

The subject matter described herein includes methods, systems, and computer program products for enabling cross language access of an addressable entity. Cross-language access of an addressable entity may be enabled through a process of compiling first source code written in a first programming language including a reference to an addressable entity, compiling second source code including the referenced addressable entity written in a second programming language, and associating the reference with the referenced entity through symbol resolution by one of the plurality of linkers and/or loaders associated with the plurality of compilers utilized for compiling the reference and the referenced entity. A cross language reference of addressable entities may be explicitly identified in a source code program or may be implicitly defined in a compiler using a compiler configuration definition. A cross language reference may also be resolved through a process of associating an unresolved reference in a first object module generated from a source code file written in a first programming language with a matching symbol in a second object module generated from a source code file written in a second programming language.

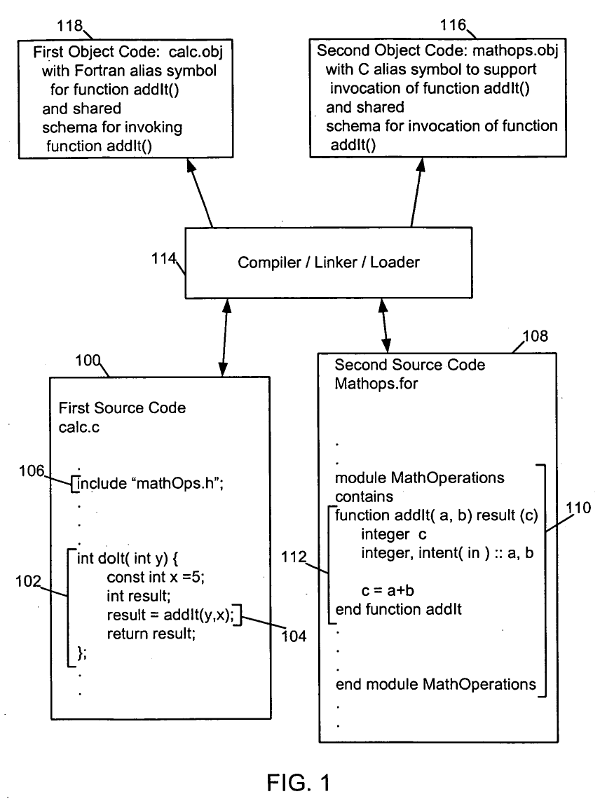

FIG. 1 may be used to describe at least two embodiments of the subject matter described herein. In a first embodiment the referencing source language compiler generates an alias symbol from the namespace of the referenced source language addressable entity. In a second, embodiment, the referenced source language addressable entity compiler generates an alias symbol from the namespace of the referencing source code entity. Both embodiments may coexist as FIG. 1 depicts.

FIG. 1 illustrates an exemplary C source code listing calc.c 100 including an exemplary source code access of an addressable entity which may be from source written in a language other than C according to an embodiment of the subject matter described herein. In FIG. 1, calc.c source code listing 100 may contain a function doIt( ) 102 which includes an invocation of a function addIt( ) 104. Listing 100 may also contain an include a statement 106 including a “mathOps.h” file which contains a declaration required by the C language listing 100 for the addIt( ) 104 function provided outside the bounds of source code listing 100. The declaration of addIt( ) in the “mathOps.h” include file may also indicate that the function call requires two integers as input parameters and returns an output value in integer format. In an embodiment where the compiler of the referenced entity may generate an alias symbol, “mathOps.h” may be generated by the compiler of the addIt( ) routine. Alternately, “mathOps.h” may be generated by a user using a text or source code editor. The method described allows the addIt( ) reference 104 to be linked to an object module generated from C language source and allows the reference 104 to be linked to an object module generated by a language other than C.

FIG. 1 also illustrates an exemplary Fortran 90 module source code listing Mathops.f90 108. The source code listing Mathops.f90 108 includes the addIt( ) function 112, which is an example of an addressable entity which may be externally invoked according to an embodiment of the subject matter described herein. A module MathOperatons 110 in source code listing 108 for Mathops.f90 may include the function addIt( ) 112 defined as a function that adds two input integer values to generate an output integer value. AddIt( ) function 112 in Mathops.f90 is an example of an addressable entity that may be referenced and accessed from calc.c's object code, as illustrated by the reference to addIt( ) 104 in the source code for calc.c. addIt( ) 112 may also be invoked by object code generated from another Fortran 90 source by a compile/link/and load process using a Fortran 90 compiler/linker/loader. Normally, since addIt( ) is a Fortran 90-defined entity, it may only be referenced using a Fortran 90-compatible name and Fortran 90-compatible execution model. Because conventional C compilers use C-compatible names and execution model, a method must be provided for the C compiler, linker, or loader to generate an alias symbol for addIt( ) in the Fortran 90 namespace and to access addIt( ) using a compatible execution model. That is, the execution model used for accessing and processing addIt( ) 112 must be shared between the two languages involved.

Accordingly, in one aspect of the subject matter described herein, at least one of a compiler, linker, or loader function of a compiler/linker/loader 114 compatible with the first programming language, the second programming language, or both may detect the reference to the addressable entity and generate object code using a shared execution model associated with the referenced addressable entity. Typically, each language has its own compiler and may have a language specific linker and/or loader. Compiler/linker/loader 114 represents this typical situation and may represent a plurality of compilers, linkers, and loaders supporting a plurality of programming languages, but is depicted as a single common component for ease of illustration.

For example, if compiler/linker/loader 114 includes a Fortran 90 compiler that is being called to compile Mathops.f90 108, the Fortran 90 compiler may detect addIt( ) 112 within the source code. The Fortran 90 compiler may determine that addIt( ) 112 is to be compiled such that it is accessible via source code compiled by a C compiler. Accordingly, the Fortran 90 compiler may generate an alias symbol for addIt( ) from the C language namespace and object code using an execution model for addIt( ) 112 where the execution model is also available for use by a C compiler when compiling a portion of source code using a reference to an addressable entity compatible with the addIt( ) 112 routine, such that references to addIt( ) 104 in object code generated from C language source listing 100 may be linked to the addIt( ) 112 addressable entity in Fortran 90 object code. In general, addIt( ) 112 may be used to resolve a compatible unresolved reference in any other object module generated from a non-Fortran 90 language when the language compiler generates object code associated with a use of the reference by using the shared execution model regardless of the source language used by the language compiler/linker/loader. In this example, the Fortran 90 compiler may generate an alias symbol from the namespaces of each other language allowed access. Alternately, a C compiler or compilers compatible with any number of languages that support the shared execution model may include generating a symbol for addIt( ) 104 from the namespace used by the Fortran 90 compiler.

In another example, compiler/linker/loader 114 may include a C compiler that encounters the call to addIt( ) 104 during compiling of calc.c 100. A C compiler may detect that addIt( ) 104 may be resolved to a Fortran 90 routine, for example, through a compiler option setting or through a C language extension identifying that the referenced addressable entity may be a Fortran 90 routine. Accordingly, the C compiler may generate an alias symbol for addIt( ) 104 that is compatible with the Fortran 90 namespace. The C compiler may also generate a symbol for addIt( ) 104 in the C namespace. The C compiler may associate the alias symbol for addIt( ) 104 in the Fortran 90 namespace and the symbol from the C namespace with references for addIt( ) 104. The association may be created in a symbol table generated by the C compiler. The compiler, linker, and/or loader may also generate object code associated with a reference to addIt( ) using a shared execution model shared by all language tools such as compilers, linkers, and loaders which process references to addIt( ).

If a Fortran 90 compiler is responsible for generation of an alias symbol, the result of the compiling process may be a Mathops.obj file with a C alias symbol and shared execution model for addIt( ) 112, as illustrated by block 116 in FIG. 1. If a C compiler is responsible for generation of an alias symbol, the result of the compiling process may be a portion of an object module associated with the reference with a Fortran 90 alias symbol for addIt( ) 104 and generated using an execution model shared with a Fortran 90 compiler for use in processing of the cross language addressable entity, addIt( ) 112 enabling a linker to link compatible object code references 104 compatible with addIt( ) 112 to addIt( ) 112 in the Mathops object code, as illustrated by block 118 in FIG. 1. Either or both compilers may produce alias symbols, and both must used a shared execution model for generated object code associated with access to addIt( ) 112.

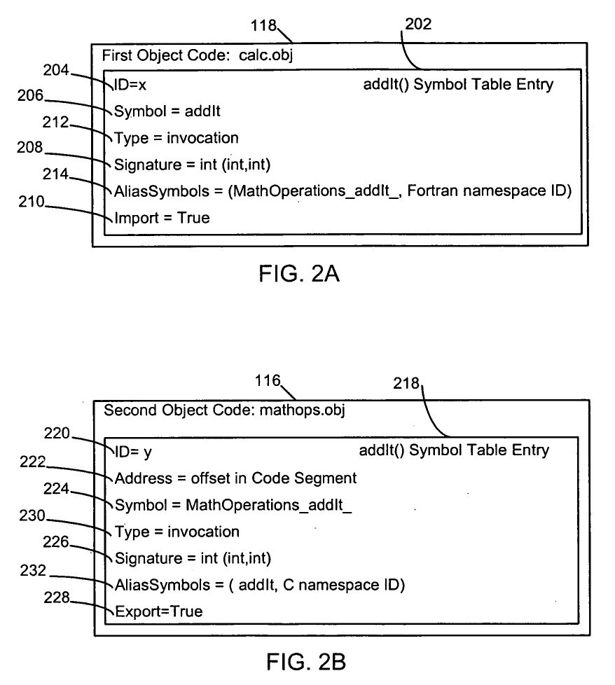

FIG. 2A illustrates an exemplary symbol table entry in object code file 118 that may be generated by complier/linker/loader 114 during compiling of calc.c listing 100 according to an embodiment of the subject matter described herein. In FIG. 2A, object code file 118 may include a symbol table entry 202, which may further include a symbol table identifier field 204, a symbol field 206, and a signature template field 208. A symbol provided in symbol field 206 may conform to a namespace defined and managed by a C compiler. Signature template 208 may define the number and type of input parameters and the presence of an output or result parameter for a procedure, function, method, or other addressable instruction entity invocation or may provide a signature specifying the order and type of elements in an addressable data entity. For example, a symbol table entry 202 for function addIt( ) 104 may include “x” in the symbol identifier field 204, a string “addIt” in the symbol field 206, and a string “int(int,int)” in the signature template field 208 indicating two integers as input parameters and a result returned as an integer.

An import field 210 and a type field 212 may be included in symbol table entry 202. Type field 212 may indicate the type of access, such as invocation access or data access. Invocation and data access may be sub-typed. Import field 210, may indicate whether the symbol table entry 212 refers to an addressable entity outside the object module associated with the symbol table. For example, a symbol table entry 202 corresponding to source code line 106 for function reference addIt( ) 104 may comprise a string “Type=invocation” for type field 212 to indicate the reference is a function and a string “Import=TRUE” field 210 to indicate that addIt( ) 104 may be imported.

An alias symbol field 214 may be provided in symbol table entry 202. Alias symbol field 214 may store a symbol for the referenced addressable entity using a name compatible to the language namespace in which the access may be resolved. For example, a symbol table entry 202 for reference to function addIt( ) 104 may comprise a string “(MathOperations_addIt_, Fortran 90 Namespace ID)” for alias symbol field 214, in order to support resolution of reference to addIt( ) 104 to function addIt( ) 112 located in an object module that includes addIt( ) compiled from Fortran 90 source code file mathops.f90 108.

FIG. 2B illustrates an exemplary symbol table entry that may be included in object code file 116 and that may be generated by a Fortran 90 compiler function of compiler/linker/loader 114 to create a C-accessible version of addIt( ) 112. In FIG. 2B, object module 116 may include a symbol table entry 218, which includes a plurality of symbol table elements required to support access to function addIt( ) 112 in object code generated from Fortran 90 source code listing 108. Source code listing 108 may not contain an explicit keyword identifier to signal the compiler that function addIt( ) 112 may be exported to enable cross-language linking and access to addIt( ) 112 via symbol table entry 218. In order for a Fortran 90 compiler to create an exported symbol table entry enabling cross-language access to function addIt( ) 112 via symbol table entry 218, the compiler may be provided with a separate configuration definition with an indication that function addIt( ) 112 may be referenced object code written in a language other than Fortran 90, either in a configuration definition file, a command line option, or through a separate build tool as described in detail later in this specification.

In the illustrated example, symbol table entry 218 includes a symbol table identifier field 220, an address field 222, a symbol field 224, and a signature template field 226. A symbol provided in symbol field 224 may conform to a namespace defined and managed by the Fortran 90 compiler. Signature template 226 may define the number and type of input parameters and the presence of an output or result parameter for the procedure call. For example, a symbol table entry 218 for function addIt( ) 112 may include “y” in the symbol identifier field 220, a code segment offset address for the first object code instruction of addIt( ) 112 in address field 222, a string “MathOperations_addIt_” in the symbol field 224, and a string “int (int, int)” in the signature template field 226 indicating two integers as input parameters and a result returned as an integer. A type field 230 may be included in symbol table entry 218 analogous to the type field in symbol table entry 202. Type field 230 indicates that addIt( ) 212 is a function.

An export field 228 may be included in symbol table entry 218. Export filed 228, may indicate whether the addressable entity may be exported. Note an import field and export field are mutually exclusive in a symbol table entry. An exemplary symbol table entry 218 supporting access to function addIt( ) 112 may be a string “Export=True” indicating that symbols associated with object code for addIt( ) 212 may be exported for use by a linker in resolving a compatible reference in another object module.

An alias symbol field 232 may be provided in symbol table entry 218. Alias symbol field 232 may include a symbol for the addressable entity using a name compatible with a language namespace from which the entity may be invoked. For example, a symbol table entry 218 for function addIt( ) 112 in source listing 108 may include a string “(addIt, C Namespace ID)” for alias symbol field 232, in order to support access to addIt( ) from object code loaded from object calc.obj file 200 compiled from C source code file calc.c 100. Some languages have no standard namespace, so an indication of the specific namespace supported is necessary in some cases. A namespace identifier may be included in the alias symbol field 232. For example, an ID for a C namespace may be added for the C alias symbol “addIt”.

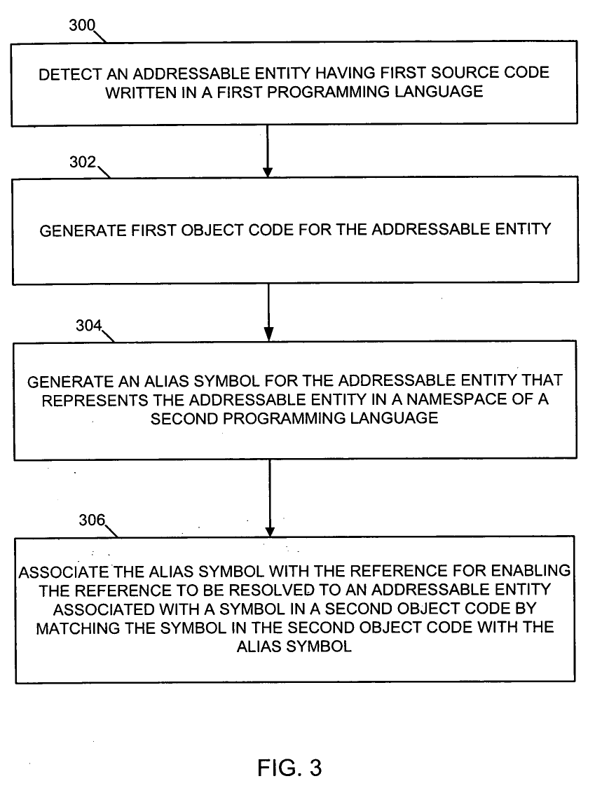

FIG. 3 is a flow chart of an exemplary process for enabling cross language access to an addressable entity. Referring to FIG. 3, in block 300, an addressable entity having first source code written in a first programming language is detected. In block 302, first object code for the addressable program entity is generated. In block 304, an alias symbol for the addressable entity that represents the addressable entity in a namespace of a second programming language is generated. In block 306; the alias symbol is associated with the addressable entity for enabling a reference associated with a symbol in a second object code generated from second source code written in the second programming language to be resolved to the addressable entity by matching the symbol in the second object code with the alias symbol.

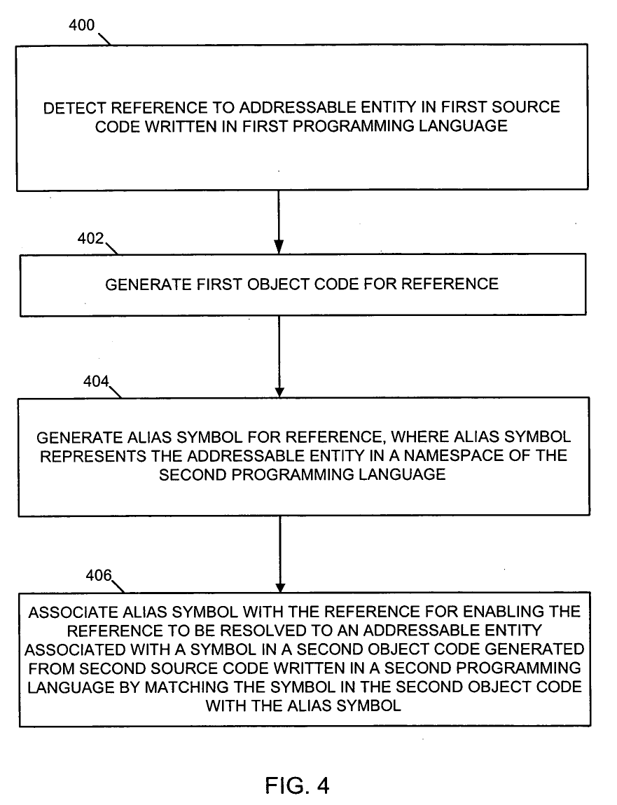

FIG. 4 is a flow chart of an exemplary process for enabling cross language access to an addressable entity. Referring to FIG. 4, in block 400, a reference to an addressable entity is detected in first source code written in a first programming language. In block 402, first object code is generated for the reference. In block 404, an alias symbol is generated for the reference. The alias symbol represents the addressable entity in a namespace of the second programming language. In block 406, the alias symbol is associated with the reference for enabling the reference to be resolved to an addressable entity associated with a symbol in a second object code generated from second source code written in the second programming language by matching the symbol in the second object code with the alias symbol.

### Exemplary Source Code Constructs to Facilitate Cross-Language Accesses

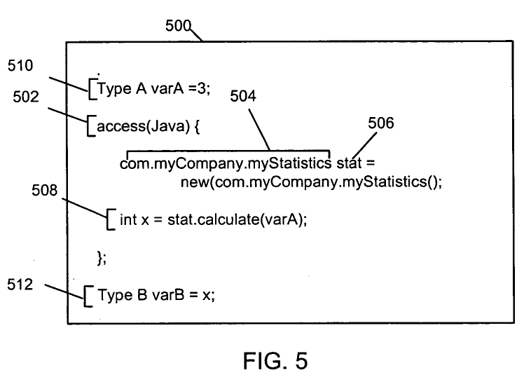

As stated above, one method for providing cross language access to addressable entities may include providing language constructs to facilitate cross language access. FIG. 5 illustrates a partial exemplary C source code listing 500 including a construct for identifying a call to an addressable entity in another language embedded in the C source code according to an embodiment of the subject matter described herein. In FIG. 5, an exemplary new C language construct, access(languageName) { . . . } 502 may be included in a C source file 500 to access an external addressable entity written in a language identified by “languageName” which is Java in construct 502. For example, construct access (Java) { . . . } 502 may be instantiated using Java syntax, operators, and/or keywords. In construct 502 an instance of the java class “.com.myCompany.myStatistics 504 name “stat” 506 is created using Java's new operarator. In line 508 the “calculate( ) method of “stat” 506 is invoked with C variable varA 510 of type “A” passed as a parameter. The result of the method call is placed in Java integer variable “x”. Finally, in line 512 after control has been returned from the construct 502, the value in Java integer variable “x” is stored in C variable varB of type B.

The compile, link, and load process for C source code 500, which includes the construct access(Java) { . . . } 502, may generate object code compatible with invoking Java addressable entities via a Java virtual machine or object code compatible with invoking Java derived addressable entities directly by accessing machine code generated from Java byte code. The machine code may be organized in object modules including symbol tables with linking cross-language references using alias symbols as has been described previously.

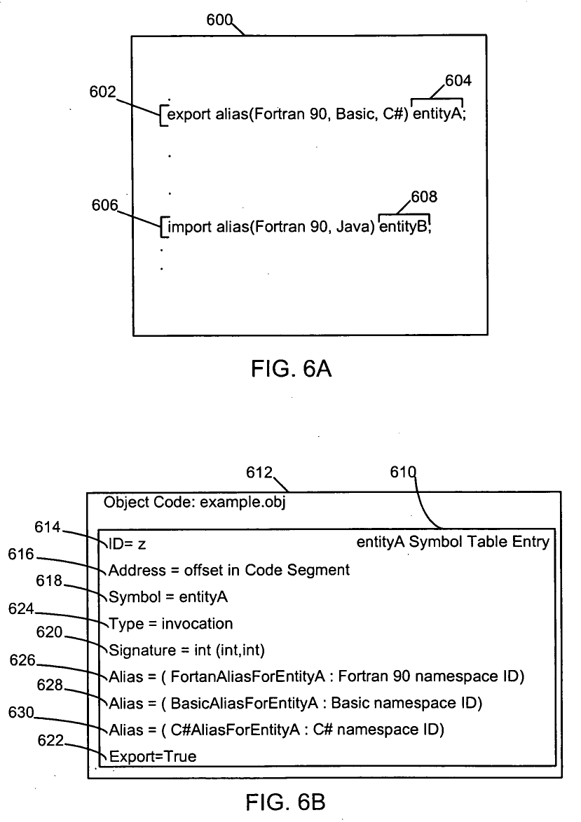

Another approach to providing cross language access is to provide constructs in the first source code that identifies the language of the accessed entity and reference to an addressable entity written in the first source code. FIG. 6A illustrates an example of first source code including such constructs. In FIG. 6A, a partial exemplary C source code listing 600 includes an export construct 602 identifying an addressable entity 604 that is accessible to object code written one or more specified languages. The export construct 602 includes an explicit identifier of one or more foreign programming languages using the “alias” attribute. In FIG. 6A, source code listing 600 includes an export construct 602 identifying an addressable entity, entityA 604, which may be accessed via a reference in an object module written generated from a Fortran 90 source file, a Basic source file, and/or a C# source file. Import construct line 606 may identify an external addressable entity, entityB 608, which may be accessed via a reference in source code listing 600 and may be implemented in a separate Fortran 90 object module or a separate Java object module. A C compiler operating on construct lines 602 or 606 may create one or more symbol table entries to capture the appropriate reference information, including an alias symbol of each explicitly identified possible foreign programming language generated addressable entity and/or reference, in addition to object code to properly implement the defined access for each cross-language reference and each cross-language referenced addressable entity. It is understood that constructs 602 and 606 may include any number of references to foreign programming languages arranged in any suitable order. It is also understood that the addressable entities identified by constructs 602 and 606 may further include data variables and constants both simple and structure, as well as functions, subroutines, classes, methods, labeled instructions, or any other type of addressable data entity or addressable instruction entity.

FIG. 6B illustrates an exemplary symbol table entry defining an addressable entity which may be accessed from a program written in any of a plurality of explicitly identified programming languages according to an embodiment of the subject matter described herein. In FIG. 6B, symbol table entry 610 may be generated by a C compiler in object code file 612 based on export construct 602 in source code listing 600. Symbol table entry 610 may include a symbol table identifier field 614, an address field 616, a symbol field 618, and a signature template field 620. A symbol identified in symbol field 618 may conform to a namespace defined and managed by the C compiler. Signature template 620 may define the number of input parameters and the presence of an output or result parameter for an external procedure call. Signature template 620 may also identify the data type assigned to each parameter. For example, symbol table entry 610 for entityA 604 may include “z” in symbol identifier field 614, a string “entityA” in the symbol field 618, a code segment offset address for the location in a code segment of the object code for the associated addressable entity in address field 616, and a string “int (int, int)” as the signature template 620 indicating two integers as input parameters and a result returned as an integer.

To support linking with other object code, an export field 622 and a type field 624 may be instantiated in symbol table entry 610. For example, symbol table entry 610 corresponding to export construct 602 may include a string “Type=invocation” for type field 624 and a string “Export=True” for export field 622 to support resolution of a plurality of access references to entityA 604.

An alias symbol entry may be provided in symbol table entry 610 for each foreign language namespace identified in export construct 602. For example, symbol table entry 610 may include an entry “Alias=(=:FortanAliasForEntityA:Fortran 90 Namespace ID)” 626 in order to support an access to entityA 604 from object code generated from a source code file written and compiled in Fortran 90, an entry “Alias=(BasicAliasForEntityA:Basic Namespace ID)” 628 in order to support an access to entityA 604 from object code generated from a source code file written and compiled in Basic, and an entry “Alias=(C#AliasForEntityA: C# Namespace ID)” 630 in order to support access to entityA 604 from object code generated from a source code file written and compiled in C#. The second portion of each alias entry identifies the namespace and the first portion is an alias symbol for “entityA” from the specified namespace.

### Exemplary Execution Model for Cross-Language Accesses Resolved During Compilation, Linking, and Loading

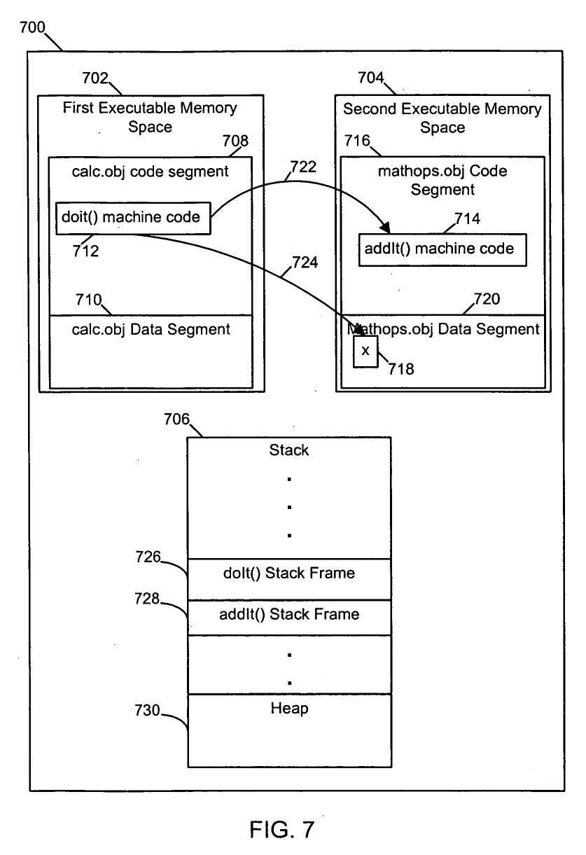

As stated above, one aspect of enabling cross-language support of access to program entities includes ensuring that the execution model of an accessed entity is compatible with the execution model used to generate object code for accessing the entity. Exemplary execution model aspects that may be required to be compatible include memory layout and management models, such as stack formats. In one exemplary entity implementation, the object modules generated from different languages may utilize a common execution model as the standard execution model for addressable entities in both object modules. FIG. 7 is a block diagram illustrating an exemplary execution environment that may be used by object modules generated from different programming languages according to an embodiment of the subject matter described herein. In FIG. 7, an execution environment 700 may include a first executable memory space 702 and a second executable memory space 704. First executable memory space 702 may include a calc.obj code segment 708 loaded from object code file calc.obj compiled, linked, and loaded from calc.c source code 100 written in C, plus a calc.obj data segment 710 also loaded from calc.obj 118. Calc.obj code segment 708 may include machine code for a function doIt( ) 712 which may include an invocation of addIt( ) 714 located in a mathops.obj code segment 716 loaded from object module mathops.obj, plus a reference to an external data variable X 718 located in a mathops.obj data segment 720 loaded from mathops.obj in second executable memory space 704. Second executable memory space 704 may include mathops.obj code segment 716 and mathops.obj data segment 720 loaded from object code file mathops.obj code segment 716 compiled, linked, and loaded from source code program mathops.f90 108 written in Fortran 90, which includes data variable X 718 in mathops.obj data segment 720. Calc.obj code segment 708 may include a symbol table entry and object code to permit proper access to addIt( ) 714 from within function doIt( ) 712 using resolved reference 722. Calc.obj code segment 708 may also include a symbol table entry and object code to permit proper access of variable X 718 using resolved reference 724. FIG. 7 depicts a thread or process in the execution environment which has invoked an instance of doIt( ) 712 with associated doIt( ) stack frame 726. doIt( ) 712 has accessed variable X 718 via a direct memory access and doIt( ) has called addIt( ) 714 using associated addIt( ) stack frame 728. Note that data region 706 provides storage for both the process/thread stack and heap 730 for dynamic memory allocation. This state is enabled by the use of a shared execution model by the compilers, linkers, and loaders used to generate the object code in first executable memory space 702 and second executable memory space 704, and by the use of alias symbols to resolve access references from object code in one executable memory address space to the other by one or more linking operations.

Calc.obj code segment 708 and mathops.obj 714 may be generated such that they run using substantially identical execution models. At the machine code level, access to addressable entities may be provided through using shared aspects of the execution model including data alignment model and/or stack frame format and layout model, and register usage model. An access from calc.obj code segment 708 to an addressable entity 714 in mathops.obj code segment 716 via resolved reference 722 may thus be implemented as a standard function invocation within the execution model. For example, the C compiler, linker, and loader generating calc.obj code segment 708 and calc.obj data segment 710 may include an object code sequence that causes an invocation of addIt( ) 714 in mathops.obj code segment 716 generated by a Fortran 90 compiler, linker, and loader which may use a Fortran 90 function invocation model rather than a C function invocation model. This implies that the stack model and use and register usage model also is compatible with the Fortran 90 invocation model.

In another exemplary embodiment, a Fortran 90 compiler, linker, and loader generating mathops.obj code segment 716 and mathops.obj data segment 720 may include object code to allow access to addIt( ) 714 using a function invocation model native to a C compiler. In this embodiment, the C compiler, linker, and loader generating calc.obj code segment 708 and calc.obj data segment 710 may generate object code for addIt( ) 714 as though the source code for addIt( ) 714 were written in C. This implies that the stack model and use, and register usage model also conforms to the C invocation model.

In yet another exemplary embodiment, the C compiler, linker, and loader generating calc.obj code segment 708 and calc.obj data segment 710 and the Fortran 90 compiler, linker, and loader generating mathops.obj code segment 716 and mathops.obj data segment 720 may both utilize an access model defined independent of the languages such as an access model included in an execution model used determined by another system entity, such as execution model defined by an embodiment of a database execution environment described in the above-referenced commonly-assigned patent application. Differences in data type definitions may be handled by each compiler by producing machine code that performs a conversion of the size, similar to processes utilized by compilers to perform data type conversions within the native language they are designed to compile. For example, if function doIt( ) 712 in calc.obj code segment 708 references variable X 718 as a 16-bit value, and mathops.obj code segment 716 defines variable X 718 to be an 8-bit variable, object code generated for calc.obj code segment 708 may access variable X 718 and place the received 8-bit value in a 16-bit register, forcing each of the unused bits in the 16-bit register to be zero.

In embodiments where languages use a shared execution model as their default model enable linking to take place using conventional address fix-ups widely used by most linkers. Alias symbols enable unresolved references and referenced addressable entities to be matched. When a match occurs the unresolved reference is resolved by storing an address or a portion of an address such as an offset in place of the reference in the accessing object code. For example, a symbol table entry for addIt( ) 714 and/or variable X 718 in calc.obj code segment 708 and/or calc.obj data segment 710, respectively 708 may include specific memory location addresses or offsets, and calc.obj code segment 708 may include machine code that makes use of a common execution model including a stack model and usage model, a common register usage model, a common memory alignment model to enable a direct memory access when either resource is accessed. In this example, resolved reference 722 may be used in a call to the starting address of function addIt( ) 714 with a stack frame 728 including storage areas for parameters, instance data and return results, and registers containing values enabling access by addIt( ) 714 to the stack frame.when accessed from doIt( ) 712 in calc.obj code segment 708. Similarly, a read or write access to variable X 718 from doIt( ) 712 using resolved reference 724 is enabled using machine instructions capable of making a direct memory access to the appropriate location within mathops.obj data segment 720 associated with code segment calc.obj. In this example, resolved reference 724 may be implemented as a direct memory read or write operation to or from a specific memory location.

FIG. 7 depicts the operation of a process or thread processing instructions from both executable memory spaces 702 and 704 where the generated object code in both memory spaces is generated using a common execution model by compilers, linkers, and loaders of both languages in generating the code segments 708 and 716, and the data segments 710 and 720. The execution model requires a stack 706 as part of its function invocation model. For example, FIG. 7 depicts an exemplary processing state where an instance of doIt( ) 712 has been invoked as evidenced by the presence of a doIt( ) stack frame 726 in stack 706. In the function invocation model stack frames are used to pass parameters, provide instance variables, return function results, and track the location to which processing control may be returned upon function return. Additionally, the invocation model includes the specification of the layout, order, and memory alignment used in creating and using each stack frame and register usage model enabling access to elements of a stack frame by the using object code. Continuing with the example depicted in FIG. 7, doIt( ) 712 is enabled to directly access variable X 718 stored in mathops.obj data segment 720. Access is enabled because the execution model shared in the generation of doIt 712 in calc.obj code segment 708, and X 718 in mathops.obj data segment 720 produces object code in doIt( ) 712 in which the reference to X in doIt( ) 712 results in the generation of code that is compatible with the type, size, and memory model used in generating the data storage area for X 718. Additionally, the figure depicts that doIt( ) 712 has invoked addIt( ) 714 via use of stack frame 728 in stack 706. This is enabled by the shared execution model resulting in object code in both doIt( ) 712 and addIt( ) 714 using the same stack frame model and register usage model allowing doIt( ) 712 to create stack frame 728, store input parameters, and a return address, a pass control to addIt( ) 714 enabling addIt( ) 714 to access stack frame 728 via the register setup resulting from the invocation. addIt( ) 714 is enabled to access parameter data, instance variable storage in stack frame 728, and store results in stack frame 728 prior to returning processing control via the return address in stack frame 728. Thus use of a common execution model in the generation of object code from calc.c and mathOps.f90 by their respective compilers, linkers, and loaders enables cross language access of both functions and data.

Exemplary Compiler Tool for External Reference Resolution

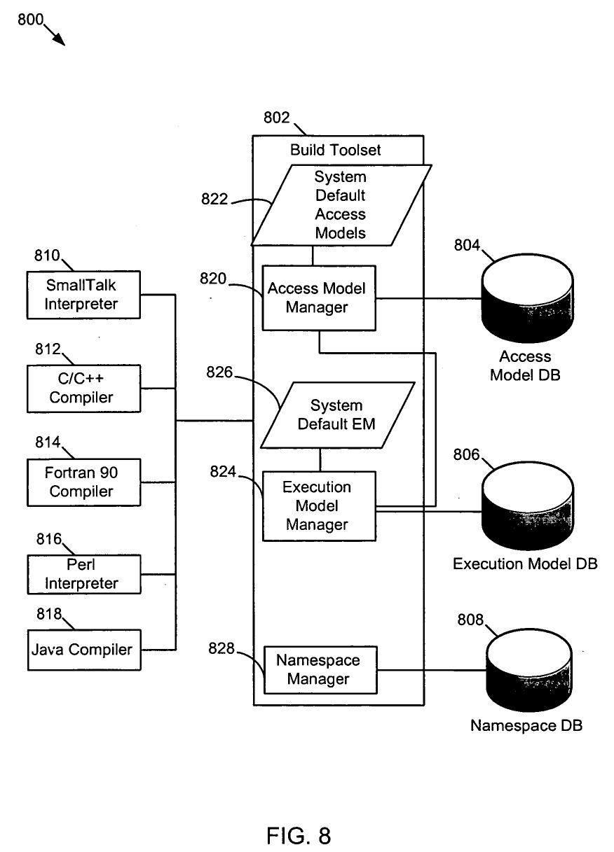

In each of the exemplary external references described above, at least one of a compiler, a linker, and a loader operating on a source file and representations of the source file including an access of an external addressable entity may resolve an alias symbol using an alien namespace mapping. However, the source code file may not include sufficient information to generate an alias symbol in order to permit the reference to be directly resolved in a namespace associated with a foreign programming language compiler. Additional information may be provided directly to the source code compiler and associated linker and loader in order to locate, resolve, and enable access to the target addressable entity in the host computer system. FIG. 8 presents an exemplary embodiment of an exemplary set of build tools that may be utilized by a compiler, a linker, and/or a loader to resolve a cross language access to an addressable entity according to an embodiment of the subject matter described herein. In FIG. 8, a system 800 for providing cross-language access to an addressable entity may include a build toolset 802, a access model database 804, an execution model database 806, a namespace database 808, plus a plurality of compilers or interpreters and associated linkers and loaders (not shown) supporting a plurality of programming languages, including a SmallTalk interpreter 810, a C/C++ compiler 812, a Fortran 90 compiler 814, a Perl interpreter 816, and a Java compiler 818.

Build toolset 802 may further include a plurality of database managers and default models. Access manager 820 may control a set of default access models 822 as well as access model database 804 including a variety of language specific and cross-language enabling access models. Execution model manager 824 may control a default execution model definition 826 that includes the default access model 822 as well as execution model database 806, and may manage a library of language specific execution models and other cross-language enabling execution model specifications. Namespace manager 828 may control namespace database 808 and may manage a plurality of definitions of active namespaces in system 800 tracking which namespace is used by each compiler and associated linker and loader. For example, a C++ compiler which detects an external reference to a SmallTalk entity may query execution model manager 824 and namespace manager 828 to generate an alias symbol compatible with a SmallTalk namespace, and may query execution model manager 824 to retrieve an execution model compatible with an execution model used by a SmallTalk interpreter 810 in generating a reference to the addressable entity to be accessed. The retrieved execution model information may include access model information used by a SmallTalk interpreter which may be retrieved via the execution model manager 824 or via the access model manager 820. In one embodiment a compiler, linker, and/or loader associated with a first programming language may invoke a compiler, linker, and/or loader associated with a second programming language for assistance in interpreting and using an execution model familiar to the second programming language tools. Similar assistance may be available for namespace processing. Invocations for assistance may be made directly via an API supported by the tools or may be accessed via an API provided and use by build toolset 802 used and provided by a plurality of compilers, linkers, and/or loaders.

### Exemplary Resolution of A Cross-Language Access

Cross-language access may be enabled between object code that may be generated using different execution models. This may be enabled by using a shared execution model only for those portions of object code involved in a cross-language access which indirectly involves object code that uses the accessing or access cross-language object code. The system and method associated with execution environment 700 described above may be utilized for cross-language access when both object modules associated with a cross-language access have been generated using a common execution model. If the two object modules have not been created using a common execution model definition, one or more access records may be required to properly enable access to an addressable entity in one class of embodiments.

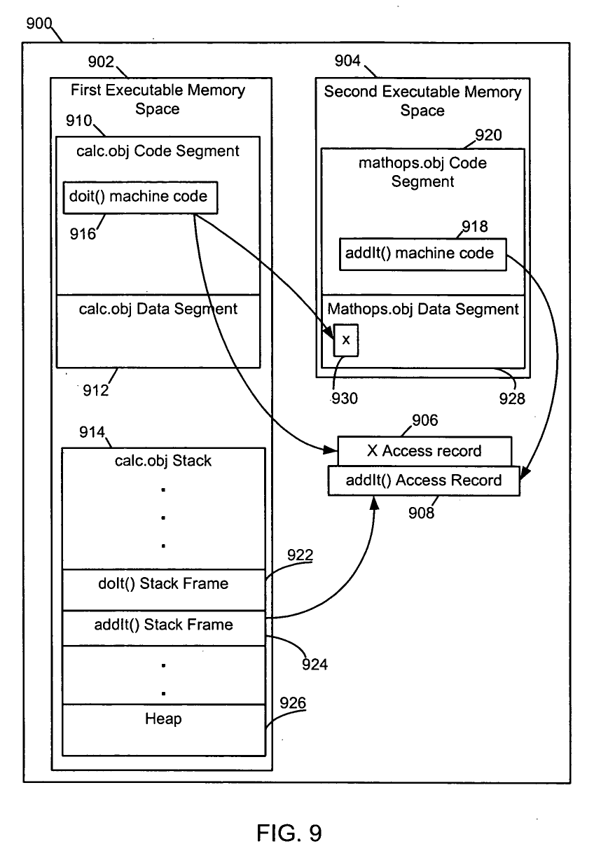

FIG. 9 illustrates an exemplary execution environment for a cross-language access enabled using an access record according to an embodiment of the subject matter described herein. The model may be utilized when the two object modules associated with a cross-language access are generated using incompatible execution models. For example, C source file calc.c 100 may include an external reference to a procedure and a variable in a module written in Fortran 90 source file mathops.f90 108 which may be resolved and processed in execution environment 900. In FIG. 9, an execution environment 900 may include a first executable memory space 902, a second executable memory space 904, plus an access record for a variable X 906 and an access record for a function addIt( ) 908. First executable space 902 may include a calc.obj code segment 910 loaded from object code file calc.obj 118, a calc.obj data segment 912 also loaded from calc.obj 118, and a process or thread processing instructions in calc.obj code segment 910 may be provide with memory for calc.obj stack 914. Calc.obj code segment 910 may include a function doIt( ) 916 with a reference to a function addIt( ) 918 located in mathops.obj code segment 920. Stack resource 914 may include a C language stack frame for an invoked instance of function doIt( ) 922, a modified C language stack frame 924 associated with an invocation of an instance of addIt( ) 924, and a common heap area 926 which may be used for dynamic memory allocation by instructions processed in the thread/process being discussed. Second executable space 904 may include a mathops.obj code segment 920 loaded from object code file mathops.obj 116 and a mathops.obj data segment 928 also loaded from object code file mathops.obj 116. mathops.obj code segment 920 may further include function addIt( ) 918. mathops.obj data segment 928 may further include data variable X 930.

To resolve cross-language references to an addressable entity, each object module contains instructions and data which make use of access records which support an execution environment supported by the compilers, linkers, and loaders of both languages, and used for possible cross-language references and referenced addressable entities as determined by the compilers, linkers, and/or loaders. For example, the machine code in calc.obj code segment 910 for function doIt( ) 916 may be generated such invocation of function addIt( ) 918 may create a modified stack 924 enabling the invocation on the thread's/process' stack 914. In the embodiment depicted the stack frame 924 may contain a pointer to an access record 908 allocated at run-time by the doIt( ) machine code processing the call to addIt( ) 918. Access record 908 may support a layout, data element order, memory byte alignment, and data element types, for example, that conform to the cross-language execution model used in generating both doIt( ) 916 and addIt( ) 918. Access record 908 may be suitable for providing storage for input and output parameters, instance data variables, and return results for use by addIt( ) 918. doIt( ) 916 machine code may use the pointer to addIt( ) access record 908 to place values for one or more input parameters for addIt( ) 918 prior to invoking addIt( ) 918. Prior to passing control to addIt( ) 918 via the memory location supplied by the linker using an alias symbol, the doIt( ) 916 machine instructions setup registers that may be used by addIt( ) 918 to access the access record 908 storage locations during processing. Access record 908, in effect, may work as a stack frame for both object modules with characteristics known to the tools that generated, linked, and loaded calc.obj code segment 910 and mathops.obj code segment 920 object modules. The known characteristics are part of the specified access execution model used by the tools. Data format type conversion may be handled by machine code generated for each source using language specific rules for type conversion when reading cross-language data and using access execution model type conversion rules when writing or providing cross-language data.

To resolve cross-language references to a foreign language generated data segment for addressable entities, an access record for the specific data transfer may be used. Object code involved in the reading and writing of possible cross-language accessible data via a data segment is generated using the access execution model. For example, shared variable X 930 may be stored in mathops.obj data segment 928 associated with mathops.obj code segment 920. When doIt( ) 916 accesses variable X, doIt 916 code may implement an indirect access through variable X access record 906 in order to ensure proper data format conversions are implemented. Variable X access record may be considered a temporary variable commonly used in compiler generated machine code. Whether the embodiment is direct or indirect depends on whether variable X access record 908 is a storage location in doIt( ) stack frame 922 or simply is a register; or whether variable X access record is allocated from using storage from heap 926. The stack and register embodiments are considered direct access embodiments. The heap storage embodiment is considered an indirect embodiment. In any case, in the embodiment depicted, machine code in doIt( ) accesses the data in variable X 930 via an address provided by a link operation using an alias symbol as previously described. The value is stored in the X access record 906 of a direct or indirect embodiment using type conversion model of the access execution model, if necessary. The doIt( ) 916 machine code performs a type conversion following its language's type conversion model and continues processing with the converted data. If no type conversions are needed, an access record is not necessary. The machine code in doIt( ) 916 may access and process variable X 930 directly. Data writes are performed analogously, with machine code in doIt( ) 916 generated to use an access record 906 prior to writing data to variable X 930 as part of type conversion processing. If no type conversion is necessary, doIt( ) 916 machine code may be generated to store data directly in variable X 930.

Access records vary according to access type and the addressable entity involved just as stack frames and data areas for data of differing types vary in a single program language generated object module. Some access records are created dynamically when they are needed and freed when no longer needed. Other access records may be static and exist for the duration of the application or other processable entity to which they belong.

In the embodiment described in relation to FIG. 9, machine code generated by both source language files may access addIt( ) 918 and variable X 930 since the compilers, linkers, and loaders for both languages may be aware of the access execution model when generating code that references entities or is referenced from entities within the native language of the tool recognizing that the reference or referenced entity may be accessed from object code generated from source code of another language. Thus the access execution model may effect the generation of machine code other than cross-language referencing or referenced addressable entities.

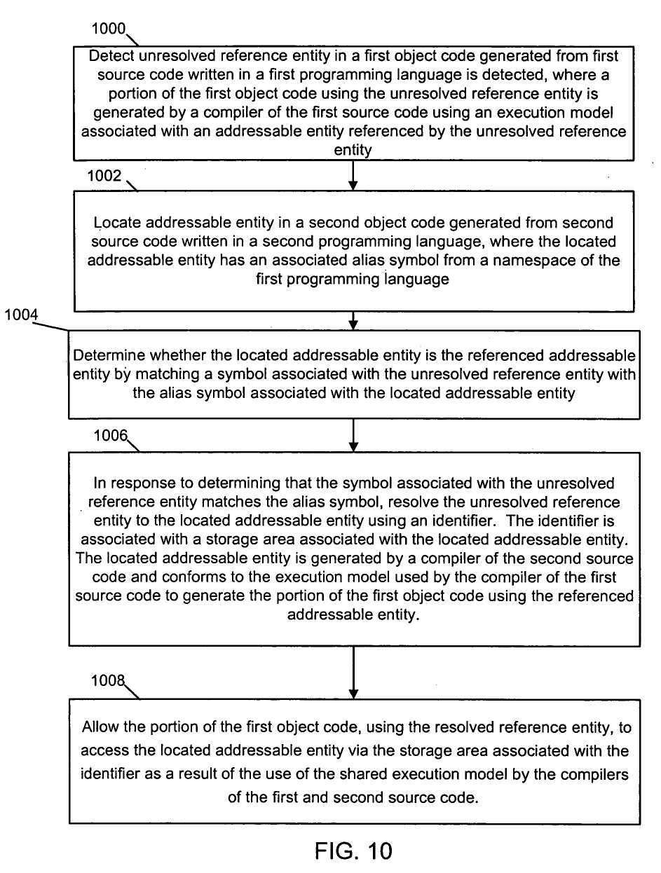

FIG. 10 is a flow chart of an exemplary process for enabling cross language access to an addressable entity in an execution environment according to an embodiment of the subject matter described herein. Referring to FIG. 10, in block 1000, an unresolved reference entity in a first object code generated from first source code written in a first programming language is detected. A portion of the first object code using the unresolved reference entity is generated by a compiler of the first source code using an execution model associated with an addressable entity referenced by the unresolved reference entity. In block 1002, an addressable entity in a second object code generated from second source code written in a second programming language is located. The located addressable entity has an associated alias symbol from a namespace of the first programming language.

In block 1004, it is determined whether the located addressable entity is the referenced addressable entity by matching a symbol associated with the unresolved reference entity with the alias symbol associated with the located addressable entity. In block 1006, in response to determining that the symbol associated with the unresolved reference entity matches the alias symbol, the unresolved reference entity is resolved to the located addressable entity using an identifier. The identifier is associated with a storage area associated with the located addressable entity. The located addressable entity is generated by a compiler of the second source code and conforms to the execution model used by the compiler of the first source code to generate the portion of the first object code using the referenced addressable entity. In block 1008, the portion of the first object code, using the resolved reference entity, is allowed to access the located addressable entity via the storage area associated with the identifier as a result of the use of the shared execution model by the compilers of the first and second source code.

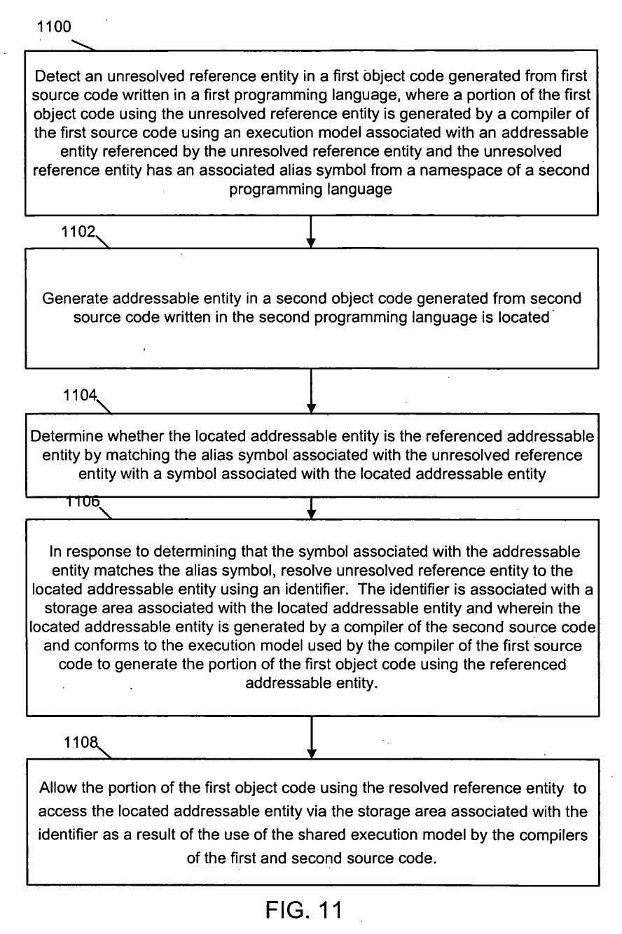

FIG. 11 illustrates an exemplary process for enabling cross language access to an addressable entity in an execution environment. Referring to FIG. 11, in block 1100, the process includes detecting an unresolved reference entity in a first object code generated from first source code written in a first programming language. A portion of the first object code using the unresolved reference entity is generated by a compiler of the first source code using an execution model associated with an addressable entity referenced by the unresolved reference entity and the unresolved reference entity has an associated alias symbol from a namespace of a second programming language. In block 1102, an addressable entity in a second object code generated from second source code written in the second programming language is located. In block 1104, it is determined whether the located addressable entity is the referenced addressable entity by matching the alias symbol associated with the unresolved reference entity with a symbol associated with the located addressable entity. In block 1106, in response to determining that the symbol associated with the addressable entity matches the alias symbol, the unresolved reference entity is resolved to the located addressable entity using an identifier. The identifier is associated with a storage area associated with the located addressable entity and wherein the located addressable entity is generated by a compiler of the second source code and conforms to the execution model used by the compiler of the first source code to generate the portion of the first object code using the referenced addressable entity. In block 1108, the portion of the first object code using the resolved reference entity is allowed to access the located addressable entity via the storage area associated with the identifier as a result of the use of the shared execution model by the compilers of the first and second source code.

A system for enabling cross-language access to an addressable entity may include at least one of a compiler, a linker, and a loader for the first programming language. The at least one of a compiler, a linker, and a loader may include means for detecting a reference to an addressable entity having first source code written in a first programming language. For example, complier/linker/loader 114 may indicate a Fortran compiler operating on a Fortran 90 source code program mathops.f90 108 that may detect a compiler directive indicating that a function addIt( ) 112 is to support an external invocation reference from object code generated from a second source code written in second programming language. The compiler directive may be provided through either a compiler configuration setting or through a compiler build tool that permits a identification accessible addressable entities that may be referenced by object modules possibly written in another programming language, as discussed above. The at least one of a compiler, a linker, and a loader may further include means for generating first object code for the addressable entity, wherein the first object code for the addressable entity includes a symbol for the addressable entity in a namespace of the first programming language. For example, compiler/linker/loader 114 may include a Fortran 90 compiler operating on a Fortran 90 source code file mathops.f90 108 that generates an object code segment 116 and a symbol table entry 218 to support an access to addIt( ) 112 from an external calling procedure written in another programming language. Identifier field 220, address field 222, symbol field 224, and signature template 226 in symbol table entry 218 may be instantiated. A symbol for function addIt( ) 112, formatted according to a namespace template utilized by the Fortran 90 compiler, may be added to symbol field 224. The at least one of a compiler, a linker, and a loader may further include means for generating an alias symbol for the addressable entity that represents the addressable entity in a namespace of the second programming language. For example, compiler/linker/loader 114 may generate an alias symbol to support access to function addIt( ) 112 from a C source using a reference associated with a symbol from a namespace utilized by a C compiler. In another exemplary application, an alias symbol may be generated to support access to addIt( ) 112 using a reference associated with an alias symbol from a namespace specified and enforced by a system execution environment, such as the database execution environment described in the above-referenced commonly-assigned patent application. The at least one of a compiler, a linker, and a loader may further include means for associating the alias symbol with the addressable entity for enabling a reference associated with a symbol in the second object code generated from second source code written in the second programming language to be resolved to the addressable entity in the first object code by matching the symbol in the second object code with the alias symbol. For example, compiler/linker/loader 114 may include a Fortran 90 linker and loader that instantiates alias symbol field 232 with the alias symbol generated for a function addIt( ) 112 in order to support an access to addIt( ) 112 from a C application program. An export field 228 and a type field 230 may also be instantiated in symbol table entry 218.

A system for enabling cross language access to an addressable entity may include at least one of a compiler, a linker, and a loader for the first programming language. The at least one of a compiler, a linker, and a loader may include may include means for detecting a reference to an addressable entity in first source code written in the first programming language. For example, compiler/linker/loader 114 may include a C compiler operating on source code program calc.c 100 that detects a reference to a function addIt( ) 104, where the function addIt( ) 112 is provided in a Fortran 90 source code program mathops.f90 108. The at least one of a compiler, a linker, and a loader may further include means for generating first object code for the reference and means for generating an alias symbol for the reference that represents the addressable entity in a namespace of the second programming language. For example, compiler/linker/loader 114 may include a C compiler, linker, and loader operating on a source code file calc.c 100 that generates a symbol table entry 202 in an object module 200 corresponding to a function addIt( ) 104, and that instantiates an identifier field 204, a symbol field 206, and a signature template field 208 according to the access to addIt( ) 104. The at least one of a compiler, a linker, and a loader may include means for associating the alias symbol with the reference for enabling the reference to be resolved to an addressable entity associated with a symbol in second object code generated from second source code written in the second programming language by matching the symbol in the second object code with the alias symbol. For example compiler/linker/loader 114 may include a C compiler that operates on a source code file calc.c 100 and generates an alias symbol 214 to support an access to addIt( ) 104 in an object module file mathops.obj 116 generated from a Fortran 90 source code file mathops.f90 108, using an symbol consistent with the conventions utilized by the Fortran 90 compiler. In another exemplary application, compiler/linker/loader 114 may generate an alias symbol 214 to support access to addIt( ) 104 using an alias symbol consistent with the conventions defined and enforced by a system execution environment, such as the database execution environment described above. Compiler/linker/loader 114 may associate an alias symbol 214 with a function addIt( ) 104 in order to support an external access to addIt( ) 112 in a Fortran 90 object module mathops.obj 116 by placing alias symbol 214 into addIt( ) symbol table entry 202. An import field 210 and a type field 212 may also be instantiated in symbol table entry 202.

A system for enabling cross language access to an addressable entity in an execution environment may include an execution environment. The execution environment may include means for detecting an unresolved reference entity in a first object module generated from first source code written in a first programming language, wherein a portion of the first object code using the unresolved reference is generated by a compiler of the first source code using an execution model associated with an addressable entity referenced by the unresolved addressable entity. For example, an execution environment such as execution environment 700, may detect an unresolved reference in machine code generated in a first programming language to an addressable entity of a second programming language. The execution environment may further include means for locating a symbol associated with an addressable entity in a second object code generated from second source code written in a second programming language, wherein the located addressable entity has an associated alias symbol from a namespace of the first programming language. For example, an execution environment, such as execution environment 700, having detected an unresolved reference to access function addIt( ) 714 may search a system registry of active object modules for a reference that matches the C namespace symbol representation for function addIt( ) 714. The execution environment may further include means for determining whether the located addressable entity is the referenced addressable entity by matching a symbol associated with the unresolved reference entity with an alias symbol associated with the located addressable entity. For example, an execution environment such as execution environment 700 may determine that an unresolved reference calc.obj code segment 708 matches an alias symbol reference discovered in a symbol table entry 218 associated with mathops.obj code segment 716. The execution environment may further include means for, in response to determining that the symbol associated with the unresolved reference entity matches the alias symbol: resolving the unresolved reference entity to the located addressable entity using an identifier, wherein the identifier is associated with a storage area associated with the located addressable entity is generated by a complier of the second source code and conforms to the execution model used by the compiler of the first source code to generate the portion of the first object code using the referenced addressable entity allowing the portion of the first object code using the resolved reference entity to access the located addressable entity via the storage area associated with the identifier as a result of the use of the shared execution model by the compilers of the first and second source code. For example, for example, an execution environment such as execution environment 700 may detect that an unresolved reference for a function addIt( ) 202 in calc.obj code segment 708 matches an alias symbol definition 232 in symbol table entry 218 for function addIt( ) 714 in mathops.obj code segment 716, and that mathops.obj code segment 716 includes the same function invocation model used by a C compiler to generate object code associate with the unresolved reference in calc.obj code segment 708. In response, the execution environment may define a direct association between unresolved reference and the storage areas associated with addIt( ) 714 by replacing the unresolved reference with an identifier for the storage areas, resolving the reference. In an execution environment, such as execution environment 700, an unresolved object code reference to of addIt( ) 714 associated with calc.c 100 statement 104 may complete operation once the unresolved reference is replaced with the identifier of the storage area associated with addIt( ) 714.

A system for enabling cross language access to an addressable entity in an execution environment may include an execution environment. The execution environment may include means for detecting an unresolved reference entity in a first object code generated from first source code written in a first programming language, wherein a portion of the first object code using the unresolved the reference entity is generated by a compiler of the first source cod using an execution model associated with an addressable entity referenced by the unresolved referenced entity and the unresolved reference entity has an associated alias symbol from a namespace of a second programming language. For example, a C compiler, linker, and/or loader 114 operating on a source file calc.c 100 may create an object code 708 and a symbol table entry 202 to support an external reference to invoke function addIt( ) 104, and may instantiate fields 204-214 using default definitions and names adhering to a Fortran 90 namespace template. The execution environment may further include means for locating an addressable entity in a second object code generated from second source code written in the second programming language. For example, an execution environment, such as execution environment 700, having detected an unresolved reference for function addIt( ) 714, the unresolved reference associated with a symbol table entry 202, may search a system registry of active object modules for references that match a Fortran 90 namespace symbol representation for function addIt( ) 714. The execution environment may further include means for determining whether the located addressable entity is the referenced addressable entity by matching the alias symbol associated with the unresolved reference entity with a symbol associated with the located addressable entity. For example, an execution environment, such as execution environment 700, may determine that an unresolved reference associated with symbol table entry 202 in object code 708 matches an alias symbol reference discovered in a symbol table entry 218 associated with mathops.obj code segment 716. The execution environment may further include means for, in response to determining that an unresolved reference matches an alias symbol, resolving the unresolved reference to the located addressable entity using an identifier, wherein the identifier associated with a storage area associated with the located addressable entity is generated by a compiler of a second source code and conforms to the execution model used by the compiler of the first source code to generate the portion of the first object code using the referenced addressable entity. For example, if an execution environment such as execution environment 700 detects that an unresolved reference for function addIt( ) 202 in calc.obj code segment 708 matches an alias symbol definition 232 for a symbol table entry 218 for function addIt( ) 714 in mathops.obj code segment 716, and that mathops.obj code segment 716 uses the same Fortran 90 compiler function invocation model used to generate object code associated with the unresolved reference in calc.obj code segment 708, the execution environment may create a direct association between the unresolved reference and the addressable entity addIt( ) 714 by replacing the unresolved reference with the identifier of the storage area associated with addIt( ) 714. The execution environment may further include means for, in response to resolving the reference, allowing the portion of the first object code using the resolved reference entity to access the located addressable entity via the storage area associated with the identifier as a result of the use of the shared execution model by the compilers of the first and second source code. For example, the object code invocation of addIt( ) 714 associated with calc.c 100 statement 104 may complete operation once the unresolved reference is replaced with the identifier of the storage area associated with addIt( ) 714 allowing the object code associated with the formerly unresolved reference to use the identifier to invoke addIt( ) object code 714 in mathops.obj code segment 716.

It will be understood that various details of the subject matter described herein may be changed without departing from the scope of the subject matter described herein. Furthermore, the foregoing description is for the purpose of illustration only, and not for the purpose of limitation, as the subject matter described herein is defined by the claims as set forth hereinafter.

1. A method for enabling cross language access to an addressable entity in an execution environment, the method comprising:
Detecting an unresolved reference entity in a first object code generated from first source code written in a first programming language, wherein a portion of the first object code using the unresolved reference entity is generated by a compiler of the first source code using an execution model associated with an addressable entity referenced by the unresolved reference entity;
locating an addressable entity in a second object code generated from second source code written in a second programming language, wherein the located addressable entity has an associated alias symbol from a namespace of the first programming language;
determining whether the located addressable entity is the referenced addressable entity by matching a symbol associated with the unresolved reference entity with the alias symbol associated with the located addressable entity; and
in response to determining that the symbol associated with the unresolved reference entity matches the alias symbol:
resolving the unresolved reference entity to the located addressable entity using an identifier, wherein the identifier is associated with a storage area associated with the located addressable entity and wherein the located addressable entity is generated by a compiler of the second source code and conforms to the execution model used by the compiler of the first source code to generate the portion of the first object code using the referenced addressable entity and
allowing the portion of the first object code using the resolved reference entity to access the located addressable entity via the storage area associated with the identifier as a result of the use of the shared execution model by the compilers of the first and second source code.

2. The method of claim 1 wherein the first and second object code use the same execution model.

3. The method of claim 1 wherein the first and second object code use different execution models and wherein allowing the portion of the first object code using the resolved reference entity to access the located addressable entity includes associating an invocation record conforming to a shared execution model with an instance of the addressable entity and allowing the first object code to access the located addressable entity via the invocation record.

4. The method of claim 1 wherein the located addressable entity comprises at least one of a data construct, an instruction, and a set of instructions.

5. A method for enabling cross language access to an addressable entity in an execution environment, the method comprising:
detecting an unresolved reference entity in a first object code generated from first source code written in a first programming language, wherein a portion of the first object code using the unresolved reference entity is generated by a compiler of the first source code using an execution model associated with an addressable entity referenced by the unresolved reference entity and the unresolved reference entity has an associated alias symbol from a namespace of a second programming language;
locating an addressable entity in a second object code generated from second source code written in the second programming language;
determining whether the located addressable entity is the referenced addressable entity by matching the alias symbol associated with the unresolved reference entity with a symbol associated with the located addressable entity; and
in response to determining that the symbol associated with the addressable entity matches the alias symbol:
resolving the unresolved reference entity to the located addressable entity using an identifier, wherein the identifier is associated with a storage area associated with the located addressable entity and wherein the located addressable entity is generated by a compiler of the second source code and conforms to the execution model used by the compiler of the first source code to generate the portion of the first object code using the referenced addressable entity; and
allowing the portion of the first object code using the resolved reference entity to access the located addressable entity via the storage area associated with the Identifier as a result of the use of the shared execution model by the compilers of the first and second source code.

6. The method of claim 5 wherein the first and second object code use the same execution model.

7. The method of claim 5 wherein the first and second object code use different execution models and wherein allowing the portion of the first object code using the resolved reference entity to access the located addressable entity includes generating an invocation record conforming to a shared execution model with an instance of the addressable entity and allowing the first object code to access the located addressable entity via the invocation record.

8. The method of claim 5 wherein the located addressable entity comprises at least one of a data construct, an instruction, and a set of instructions.

9. A system for enabling cross language access to an addressable entity in an execution environment, the system comprising:
an execution environment configured for
detecting an unresolved reference entity in a first object code generated from first source code written in a first programming language, wherein a portion of the first object code using the unresolved reference entity conforms to an execution model used by a compiler of the first source code using an execution model associated with a referenced addressable entity;
locating an addressable entity in a second object code generated from second source code written in a second programming language, wherein the located addressable entity has an associated alias symbol from a namespace of the first programming language;
determining whether the located addressable entity is the referenced addressable entity by matching a symbol associated with the unresolved reference entity with the alias symbol associated with the located addressable entity; and
in response to determining that the symbol associated with the unresolved reference entity matches the alias symbol:
resolving the unresolved reference entity to the located addressable entity using an identifier, wherein the identifier is associated with a storage area associated with the located addressable entity and wherein the located addressable entity is generated by a compiler of the second source code and conforms to the execution model used by the compiler of the first source code to generate the portion of the first object code using the referenced addressable entity; and
allowing the portion of the first object code using the resolved reference entity to access the located addressable entity via the storage area associated with the identifier as a result of the use of the shared execution model by the compilers of the first and second source code.

10. The system of claim 9 wherein the first and second object code use the same execution model.

11. The system of claim 9 wherein the first and second object code use different execution models and wherein allowing the portion of the first object code using the resolved reference entity to access the located addressable entity includes associating an invocation record conforming to a shared execution model with an instance of the addressable entity and allowing the first object code to access the addressable entity via the invocation record.

12. The system of claim 9 wherein the located addressable entity comprises at least one of a data construct, an instruction, and a set of instructions.

13. A system for enabling cross language access to an addressable entity in an execution environment, the system comprising:
an execution environment configured for:
detecting an unresolved reference entity in a first object code generated from first source code written in a first programming language, wherein a portion of the first object code using the unresolved reference entity is generated by a compiler of the first source code using an execution model associated with an addressable entity referenced by the unresolved reference entity and the unresolved reference entity has an associated alias symbol from a namespace of a second programming language;
locating an addressable entity in a second object code generated from second source code written in the second programming language;
determining whether the located addressable entity is the referenced addressable entity by matching the alias symbol associated with the unresolved reference entity with a symbol associated with the located addressable entity;
in response to determining that the symbol associated with the addressable entity matches the alias symbol:
resolving the unresolved reference entity to the located addressable entity using an identifier, wherein the identifier is associated with a storage area associated with the located addressable entity and wherein the located addressable entity is generated by a compiler of the second source code and conforms to the execution model used by the compiler of the first source code to generate the portion of the first object code using the referenced addressable entity; and
allowing the portion of the first object code using the resolved reference entity to access the located addressable entity via the storage area associated with the identifier as a result of the use of the shared execution model by the compilers of the first and second source code.

14. The system of claim 13 wherein the first and second object code use the same execution model.

15. The system of claim 13 wherein the first and second object code use different execution models and wherein allowing the portion of the first object code using the resolved reference entity to access the located addressable entity includes generating an invocation record conforming to a shared execution model with an instance of the addressable entity and allowing the first object code to access the located addressable entity via the invocation record.

16. The system of claim 13 wherein the located addressable entity comprises at least one of a data construct, an instruction, and a set of instructions.

17. A system for enabling cross language access to an addressable entity in an execution environment, the system comprising:
an execution environment including:
means for detecting an unresolved reference entity in a first object code generated from first source code written in a first programming language, wherein a portion of the first object code using the unresolved reference entity is generated by a compiler of the first source code using an execution model associated with an addressable entity referenced by the unresolved reference entity;
means for locating a symbol associated with an addressable entity in a second object code generated from second source code written in a second programming language, wherein the located addressable entity has an associated alias symbol from a namespace of the first programming language;
means for determining whether the located addressable entity is the referenced addressable entity by matching a symbol associated with the unresolved reference entity with the alias symbol associated with the located addressable entity; and
means for, in response to determining that the symbol associated with the unresolved reference entity matches the alias symbol:
resolving the unresolved reference entity to the located addressable entity using an identifier, wherein the identifier is associated with a storage area associated with the located addressable entity is generated by a complier of the second source code and conforms to the execution model used by the compiler of the first source code to generate the portion of the first object code using the referenced addressable entity; and
allowing the portion of the first object code using the resolved reference entity to access the located addressable entity via the storage area associated with the identifier as a result of the use of the shared execution model by the compilers of the first and second source code.

18. A system for enabling cross language access to an addressable entity in an execution environment, the system comprising:
an execution environment including:
means for detecting an unresolved reference entity in a first object code generated from first source code written in a first programming language, wherein a portion of the first object code using the unresolved reference entity is generated by a compiler of the first source code using an execution model associated with an addressable entity referenced by the unresolved reference entity and the unresolved reference entity has an associated alias symbol from a namespace of a second programming language;
means for locating an addressable entity in a second object code generated from second source code written in the second programming language;
means for determining whether the located addressable entity is the referenced addressable entity by matching the alias symbol associated with the unresolved reference entity with a symbol associated with the located addressable entity; and
means for, in response to determining that the symbol matches the alias symbol:
resolving the unresolved reference to the located addressable entity using an identifier, wherein the identifier is associated with a storage area associated with the located addressable entity is generated by a complier of the second source code and conforms to the execution model used by the compiler of the first source code to generate the portion of the first object code using the referenced addressable entity; and
allowing the portion of the first object code using the resolved reference entity to access the located addressable entity via the storage area associated with the identifier as a result of the use of the shared execution model by the compilers of the first and second source code.

19. A computer program product comprising computer instructions embodied in a computer readable medium for performing steps comprising:
detecting an unresolved reference entity in a first object code generated from first source code written in a first programming language, wherein a portion of the first object code using the unresolved reference entity is generated by a compiler of the first source code using an execution model associated with an addressable entity referenced by the unresolved reference entity;
locating a an addressable entity in a second object code generated from second source code written in a second programming language, wherein the located addressable entity has an associated alias symbol from a namespace of the first programming language;
determining whether the located addressable entity is the referenced addressable entity by matching a symbol associated with the unresolved reference entity with the alias symbol associated with the located addressable entity; and
in response to determining that the symbol associated with the unresolved reference entity matches the alias symbol:
resolving the unresolved reference entity to the located addressable entity using an identifier, wherein the identifier is associated with a storage area associated with the located addressable entity and wherein the located addressable entity is generated by a compiler of the second source code and conforms to the execution model used by the compiler of the first source code to generate the portion of the object code using the referenced addressable entity; and
allowing the portion of the first object code using the resolved reference entity to access the located addressable entity via the storage area associated with the identifier as a result of the use of the shared execution model by the compilers of the first and second source code.

20. A computer program product comprising computer instructions embodied in a computer readable medium for performing steps comprising:
detecting an unresolved reference entity in a first object code generated from first source code written in a first programming language, wherein a portion of the first object code using the unresolved reference entity is generated by a compiler of the first source code using an execution model associated with an addressable entity referenced by the unresolved reference entity and the unresolved reference entity has an associated alias symbol from a namespace of a second programming language;
locating an addressable entity in a second object code generated from second source code written in the second programming language;
determining whether the located addressable entity is the referenced addressable entity by matching the alias symbol associated with the unresolved reference with a symbol associated with the located addressable entity; and
in response to determining that the symbol associated with the addressable entity matches the alias symbol:
resolving the unresolved reference entity to the located addressable entity using an identifier, wherein the identifier is associated with a storage area associated with the located addressable entity and wherein the located addressable entity is generated by a compiler of the second source code and conforms to the execution model used by the compiler of the first source code to generate the portion of the object code using the referenced addressable entity; and
allowing the portion of the first object code using the resolved reference entity to access the located addressable entity via the storage area associated with the identifier as a result of the use of the shared execution model by the compilers of the first and second source code.
